(19) United States
(12) Patent Application Publication
(10) Pub. No.: US 2008/0040798 A1
(43) Pub. Date: Feb. 14, 2008

(54) INFORMATION ACCESS CONTROL METHOD AND INFORMATION PROVIDING SYSTEM

(76) Inventor: Koichi INOUE, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/835,677

(22) Filed: Aug. 8, 2007

(30) Foreign Application Priority Data
Aug. 11, 2006 (JP) 2006-220145
Jul. 30, 2007 (JP) 2007-197908

(51) Int. Cl. H04L 9/00

(52) U.S. Cl. 726/21

(57) ABSTRACT

In an information providing system, meta data is distributed to a use side apparatus and main information is accessed by the use side apparatus based on a link element contained in the meta data. Upon reception of a request from the use side apparatus, the meta data is created, which has the link element of which destination is set to an authentication substitute processing apparatus provided separately from an information source apparatus that manages information as an object of the meta data. The created meta data is returned to the use side apparatus. A request for acquiring information is received based on the link element contained in the meta data from the use side apparatus. A substitute process of authentication for the use side apparatus is performed in accordance with the received request. The main information is provided from the information source apparatus to the user side apparatus when the authentication has been done normally.

### BACKGROUND OF THE INVENTION

1. Field of the Invention

The present invention relates to information access control methods and, more particularly, to an information access control method used in a system in which main information is accessible through meta data that is described in a structured language such as RSS (RDF (Resource Description Framework) Site Summary, Rich Site Summary, Really Simple Syndication), Atom (Atom Syndication Format), etc.

2. Description of the Related Art

In these days, a technology using RSS has attracted attention. A facsimile (FAX) terminal having a function to distribute list information has been provided. Such a facsimile terminal accumulates facsimile reception image in a predetermined URL (Uniform Resource Locator) and distributes list information containing the URL as facsimile reception history (for example, refer to Patent Document 1).

In such an equipment capable of distributing URL list of object information (contents) through RSS, there is a case where access limitation is to be performed on an individual user basis or an individual machine basis when reviewing the object information from the URL provided by a user operating a computer that received RSS. It is assumed that confidentiality of data contained in RSS itself is not so high and there is no problem if the linked object information cannot be reviewed.

Conventionally, such an access control has been made to perform double authentication at a stage of acquiring RSS by a computer and at a stage of acquiring object information.

FIG. 1 is a block diagram of a conventional system including a FAX terminal having an RSS distribution function. In FIG. 1, the system includes FAX terminals F1 and F2, an LDAP (Lightweight Directory Access Protocol) server L1 and a computer C1. The FAX terminals F1 and F2 have an RSS distribution function. The LDAP server L1 is used for authentication. The computer C1 is operated by a user who reviews received facsimile.

FIG. 2 is a sequence chart indicating an example of a process performed in the conventional system. A description will be given below of an operation to review facsimile information received by the FAX terminal F1, the review being performed through the computer C1.

<Acquiring RSS>

The computer C1 sends a request and authentication information to the FAX terminal F1 (step S1). The FAX terminal F1 checks the authentication information with the LDAP server L1 (step S2), and acquire an authentication result (step S3). If the authentication result of the LDAP server L1 is NG (No Good), the FAX terminal F1 rejects the request of the computer C1, and if the authentication result is OK, the FAX terminal F1 outputs RSS of FAX reception history as a response (step S4).

<Acquiring Data>

The user selects a desired item on a screen of the computer C1 displaying FAX reception history (step S5). Then, the computer C1 extracts a link element of the selected item (step S6), and sends a request for acquiring data to the FAX terminal F1 according to URL written in the link element (step S7). The FAX terminal F1 sends a response to the computer C1 that indicates that authentication is needed to acquire data (step S8). Then, the computer C1 sends the request for acquiring data by attaching authentication information to the FAX terminal F1 (step S9).

The FAX terminal F1 checks the authentication information with the LDAP server L1 (step S10), and acquires an authentication result (step S11). If the authentication result of the LDAP server L1 is NG, the FAX terminal F1 sends a response indicating authentication failure to the computer C1, and if the authentication result is OK, the FAX terminal F1 sends data of concerned facsimile image to the computer C1 (step S12).

Patent Document: Japanese Laid-Open Patent Application No. 2006-54732

Although conventional equipments having the RSS distribution function have been used as mentioned above, the following problems have been pointed out.

(1) The equipment requires an authentication scheme by the LDAP server or the like, and when the authentication scheme is changed, the equipment itself must be replaced with new one. The authentication scheme is progressing day by day and there is a high possibility that a more effective authentication scheme will become available in the near future. However, replacement cycle of such an equipment is long and one does not want to replace such an equipment, if possible.

(2) RSS is data of standardized XML (Extensible Markup Language), and has a property that it can be handled easily with respect to alteration and aggregate. However, since an authentication process is needed for acquiring RSS from an equipment, corresponding software is limited, which prevents RSS from being used.

(3) When acquisition of RSS from equipments and access to URL contained in the RSS are performed consecutively, there is no need to perform further authentication when accessing the URL. However, RSS acquired from equipments and data after processing the RSS may be distributed freely. Thus, it is required to perform authentication at the time of accessing the URL so as to maintain security. After all, it is needed to perform double authentication, which results in redundant authentication scheme.

### SUMMARY OF THE INVENTION

It is a general object of the present invention to provide an improved and useful information access control method and information providing system in which the above-mentioned problems are eliminated.

A more specific object of the present invention is to provide an information access control method that permits minimum authentication without influences of authentication scheme by an LDAP server or the like while acquisition of meta data such as RSS is acquired easily.

In order to achieve the above-mentioned objects, there is provided according to one aspect of the present invention an information access control method in a system in which meta data described in structured language is distributed to a use side apparatus and main information is accessed by the use side apparatus based on a link element contained in the meta data, the information access control method comprising: receiving a request for acquiring meta data from the use side apparatus; creating meta data having the link element of which destination is set to an authentication substitute processing apparatus provided separately from an information source apparatus that manages information as an object of the meta data; returning the created meta data to the use side apparatus; receiving a request for acquiring information based on the link element contained in the meta data from the use side apparatus; performing a substitute process of authentication for the use side apparatus in accordance with the received request for acquiring information; and providing the main information from the information source apparatus to the user side apparatus when the authentication has been done normally.

In the information access control method according to the present invention, a provider apparatus may receive a request for acquiring the meta data from the use side apparatus; the provider apparatus may create the meta data having the link element of which destination is set to the authentication substitute processing apparatus provided separately from the information source apparatus that manages information as an object of the meta data; the provider apparatus may return the created meta data to the use side apparatus; the provider apparatus may receive a request for acquiring information based on the link element contained in the meta data from the use side apparatus; the provider apparatus serving as the authentication substitute processing apparatus may perform the substitute process of authentication of the use side apparatus in accordance with the received request for acquiring information; and when the authentication has been done normally, the main information may be provided from the information source apparatus to the use side apparatus upon an instruction from the provider apparatus.

In information access control method according to the present invention, a provider apparatus may receive a request for acquiring the meta data from the use side apparatus; the provider apparatus may create the meta data having the link element of which destination is set to the authentication substitute processing apparatus provided separately from the information source apparatus that manages information as an object of the meta data; the provider apparatus may return the created meta data to the use side apparatus; the provider apparatus may receive a request for acquiring information based on the link element contained in the meta data from the use side apparatus; the authentication substitute processing apparatus may perform the substitute process of authentication of the use side apparatus in accordance with the received request for acquiring information; and when the authentication has been done normally, the main information may be provided from the information source apparatus to the use side apparatus upon an instruction from the authentication substitute processing apparatus.

In the information access control method according to the present invention, the information source apparatus may receive a request for acquiring the meta data from the use side apparatus; the information source apparatus may create the meta data having the link element of which destination is set to the authentication substitute processing apparatus provided separately from the information source apparatus that manages information as an object of the meta data; the information source apparatus may return the created meta data to the use side apparatus; the information source apparatus may receive a request for acquiring information based on the link element contained in the meta data from the use side apparatus; the authentication substitute processing apparatus may perform the substitute process of authentication of the use side apparatus in accordance with the received request for acquiring information; and when the authentication has been done normally, the main information may be provided from the information source apparatus to the use side apparatus upon an instruction from the authentication substitute processing apparatus.

In the information access control method according to the present invention, a provider apparatus may receive a request for acquiring the meta data from the use side apparatus; the provider apparatus may create the meta data having the link element of which destination is set to the authentication substitute processing apparatus provided separately from the information source apparatus that manages information as an object of the meta data; the provider apparatus may return the created meta data to the use side apparatus; the provider apparatus may receive a request for acquiring information based on the link element contained in the meta data from the use side apparatus; the provider apparatus serving as the authentication substitute processing apparatus may perform the substitute process of authentication of the use side apparatus in accordance with the received request; and when the authentication has been done normally, the provider apparatus may acquire the main information from the information source apparatus and provides the acquired main information to the use side apparatus.

In the above-mentioned information access control method, the provider apparatus may create the meta data of which contents are sorted in an order of time based on information from a plurality of the information source apparatuses. The provider apparatus may create the meta data each time the request for acquiring information is received from the information source apparatus, or based on information that has been collected previously.

In the above-mentioned information access control method, the provider apparatus may provide the main information, in response to the request for acquiring information from the use side apparatus, through the provider apparatus itself, or by causing the information source apparatus to perform redirection.

In the above-mentioned information access control method, the authentication substitute processing apparatus may provide the main information, in response to the request for acquiring information from the use side apparatus, through the authentication substitute processing apparatus itself, or by causing the information source apparatus to perform redirection.

Additionally, there is provided according to another aspect of the present invention an information providing system in which meta data described in structured language is distributed to a use side apparatus and main information is accessed by the use side apparatus based on a link element contained in the meta data, the information providing system comprising: a meta data request receiving part that receives a request for acquiring meta data from the use side apparatus; a creating part that creates meta data having the link element of which destination is set to an authentication substitute processing apparatus provided separately from an information source apparatus that manages information as an object of the meta data; a returning part that returns the created meta data to the use side apparatus; an information request receiving part that receives a request for acquiring information based on the link element contained in the meta data from the use side apparatus; and a substitute authentication processing part that performs a substitute process of authentication for the use side apparatus in accordance with the received request for acquiring information, wherein the information source apparatus provides the main information to the user side apparatus when the authentication has been done normally.

In the information providing system according to the present invention, a provider apparatus may receive a request for acquiring the meta data from the use side apparatus; the provider apparatus may create the meta data having the link element of which destination is set to the authentication substitute processing apparatus provided separately from the information source apparatus that manages information as an object of the meta data; the provider apparatus may return the created meta data to the use side apparatus; the provider apparatus may receive a request for acquiring information based on the link element contained in the meta data from the use side apparatus; the provider apparatus serving as the authentication substitute processing apparatus may perform the substitute process of authentication of the use side apparatus in accordance with the received request for acquiring information; and when the authentication has been done normally, the main information may be provided from the information source apparatus to the use side apparatus upon an instruction from the provider apparatus.

In the information providing system according to the present invention, a provider apparatus may receives a request for acquiring the meta data from the use side apparatus; the provider apparatus may create the meta data having the link element of which destination is set to the authentication substitute processing apparatus provided separately from the information source apparatus that manages information as an object of the meta data; the provider apparatus may return the created meta data to the use side apparatus; the provider apparatus may receive a request for acquiring information based on the link element contained in the meta data from the use side apparatus; the authentication substitute processing apparatus may perform the substitute process of authentication of the use side apparatus in accordance with the received request for acquiring information; and when the authentication has been done normally, the main information may be provided from the information source apparatus to the use side apparatus upon an instruction from the authentication substitute processing apparatus.

In the information providing system according to the present invention, the information source apparatus may receive a request for acquiring the meta data from the use side apparatus; the information source apparatus may create the meta data having the link element of which destination is set to the authentication substitute processing apparatus provided separately from the information source apparatus that manages information as an object of the meta data; the information source apparatus may return the created meta data to the use side apparatus; the information source apparatus may receive a request for acquiring information based on the link element contained in the meta data from the use side apparatus; the authentication substitute processing apparatus may perform the substitute process of authentication of the use side apparatus in accordance with the received request for acquiring information; and when the authentication has been done normally, the main information may be provided from the information source apparatus to the use side apparatus upon an instruction from the authentication substitute processing apparatus.

In the information providing system according to the present invention, a provider apparatus may receive a request for acquiring the meta data from the use side apparatus; the provider apparatus may create the meta data having the link element of which destination is set to the authentication substitute processing apparatus provided separately from the information source apparatus that manages information as an object of the meta data; the provider apparatus may return the created meta data to the use side apparatus; the provider apparatus may receive a request for acquiring information based on the link element contained in the meta data from the use side apparatus; the provider apparatus serving as the authentication substitute processing apparatus may perform the substitute process of authentication of the use side apparatus in accordance with the received request for acquiring information; and when the authentication has been done normally, the provider apparatus may acquire the main information from the information source apparatus and provides the acquired main information to the use side apparatus.

In the above-mentioned information providing system, the provider apparatus may create the meta data of which contents are sorted in an order of time based on information from a plurality of the information source apparatuses. The provider apparatus may create the meta data each time the request for acquiring information is received from the information source apparatus, or based on information that has been collected previously.

In the above-mentioned information providing system, the provider apparatus may provide the main information, in response to the request for acquiring information from the use side apparatus, through the provider apparatus itself, or by causing the information source apparatus to perform redirection.

In the above-mentioned information providing system, the authentication substitute processing apparatus may provide the main information, in response to the request for acquiring information from the use side apparatus, through the authentication substitute processing apparatus itself, or by causing the information source apparatus to perform redirection.

According to the above-mentioned invention, there is no need to provide an authentication scheme to the information source apparatus such as a facsimile terminal, and also there is no need to perform an authentication process when acquiring meta data such as RSS. Thus, there is no influence given by an authentication scheme such as an LDAP server or the like, and the meta data itself can be acquired easily and minimum authentication process is achieved.

Other objects, features and advantages of the present invention will become more apparent from the following detailed description when read in conjunction with the accompanying drawings.

### BRIEF DESCRIPTION OF THE DRAWINGS

FIG. 1 is a block diagram of a conventional system including a FAX terminal having an RSS distribution function;

FIG. 2 is a sequence chart indicating an example of a process performed in the conventional system;

FIG. 3 is a block diagram of a system to which the present invention is applicable;

FIG. 4 is a block diagram of an RSS provider;

FIG. 5 is a block diagram of a FAX terminal;

FIG. 6 is an illustration of a URL rewrite condition database;

FIG. 7 is a sequence chart showing an example of a process of the system shown in FIG. 3;

FIG. 8 is an illustration showing an example of a request for acquiring RSS;

FIG. 9A is an illustration showing the RSS before rewriting;

FIG. 9B is an illustration showing the RSS after the rewriting;

FIG. 10 is an illustration showing an example of a URL rewrite condition database in a variation 1;

FIG. 11A is an illustration showing RSS acquired from a FAX terminal and before rewriting;

FIG. 11B is an illustration showing RSS acquired from another FAX terminal and before rewriting;

FIG. 11C is an illustration showing RSS after combining and rewriting;

FIG. 12 is a sequence chart showing an example of a process of the system according to a variation 2;

FIG. 13 is a sequence chart of an example of a process of the system in a variation 3;

FIG. 14A is an illustration showing a request from a computer to an RSS provider;

FIG. 14B is an illustration showing a response from the RSS provider to the computer;

FIG. 14C is an illustration showing a request from the computer to a FAX terminal;

FIG. 14D is an illustration showing a response from the FAX terminal to the computer;

FIG. 15 is a block diagram of a system according to a variation 4;

FIG. 16 is a block diagram of an authentication server according to the variation 4;

FIG. 17 is a block diagram of a system according to a variation 5;

FIG. 18 is a block diagram of a FAX terminal according to the variation 5;

FIG. 19 is a block diagram of an authentication server according to the variation 5;

FIG. 20 is a block diagram of an RSS provider according to a variation 6; and

FIG. 21 is a block diagram of a FAX terminal according to the variation 6.

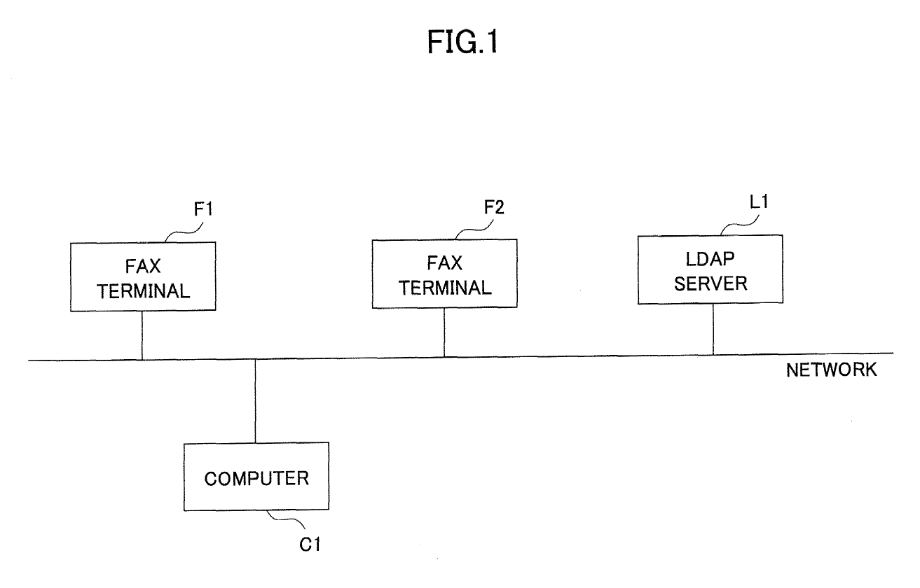

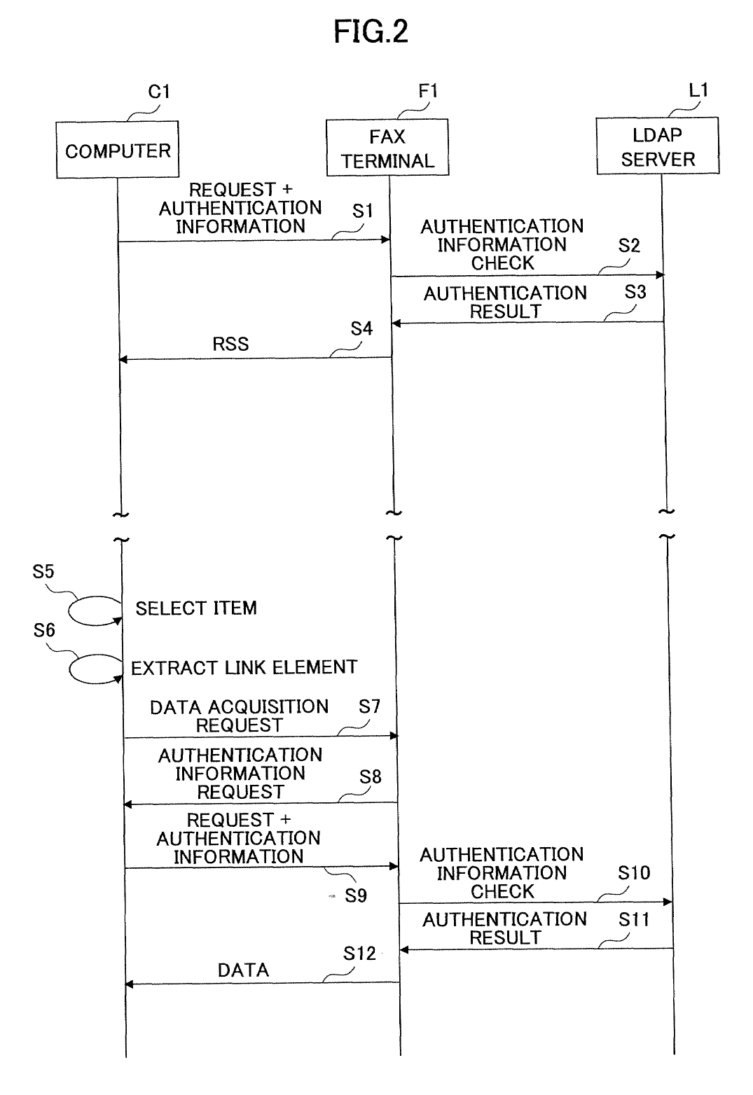

### DETAILED DESCRIPTION OF THE PREFERRED EMBODIMENTS

A description will now be given, with reference to the drawings, of an embodiment of the present invention. Although a description will be given of an example of a system containing a FAX terminal having an RSS distribution function, the present invention is not limited to such a FAX terminal.

<System Structure>

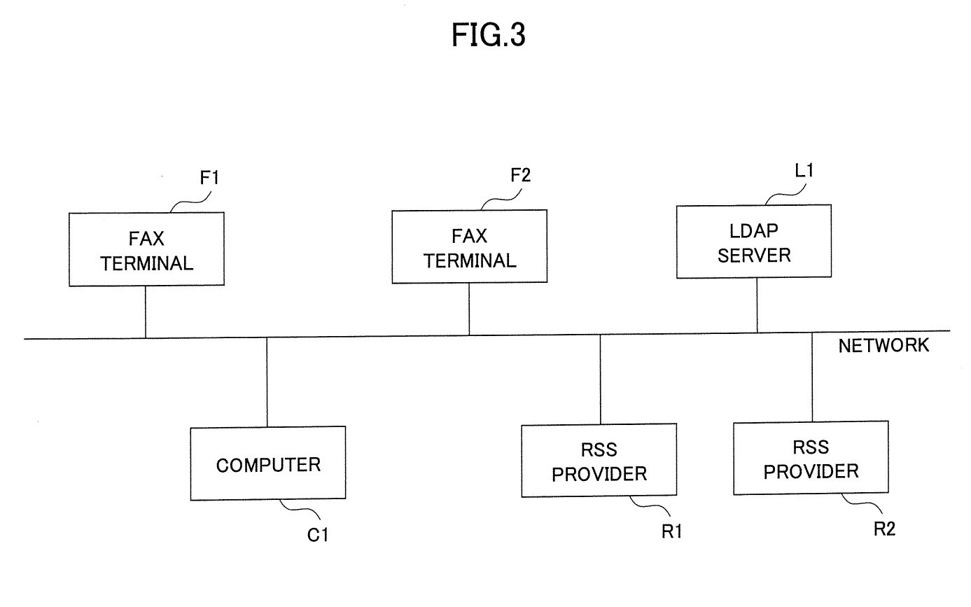

FIG. 3 is a block diagram of a system to which the present invention is applicable.

The system shown in FIG. 3 includes FAX terminals F1 and F2 having an RSS distribution function, an LDAP server L1 which provides authentication service, a computer C1 which a user operates to review received facsimile, and RSS providers R1 and R2 that intermediate RSS distributed by the FAX terminal F1 or F2. The FAX terminals F1 and F2, the LDAP server L1, the computer C1 and the RSS providers R1 and R2 are connected to a network.

Main functions of each of the RSS providers R1 and R2 are as follows.

(1) Receiving RSS from the FAX terminal F1 or F2 or another RSS provider R2 or R1, and outputting the RSS to the computer C1 which has accessed. Rewriting the contents of the link element of the RSS when outputting the RSS. According to the rewritten link element, the computer C1 that received the RSS accesses the RSS provider R1 or R2 when accessing URL which the item of the RSS indicates. At this time, authentication by the LPDA server L1 is performed for the first time.

(2) Transmitting FAX data from the FAX terminal F1 or F2 or another RSS provider R2 or R1 to the computer C1, or performing introduction by giving access right certificate information. Acquiring facsimile data from the FAX terminal F1 or F2 or another RSS provider R2 or R1 and providing the acquired FAX data to the computer C1 on the assumption that there is a confidential relationship between the RSS provider R1 or R2 and the FAX terminal F1 or F2 or another RSS provider R2 or R1. Alternatively, the FAX terminals F1 or F2 or another RSS provider R2 or R1 provides the FAX data to the computer C1 which has accessed.

(3) Each of the RSS providers R1 and R2 performs equipment authentication (equipment authentication, SSH (Secure Shell) communication, etc.) between the FAX terminal F1 or F2 according to an agreement which both can understand. Additionally, an IP address of each of the FAX terminals F1 and F2 is set so that it receives a request only from the IP addresses of the RSS providers R1 and R2. The same applies to a mac (media access control) address (usable within the same LAN segment).

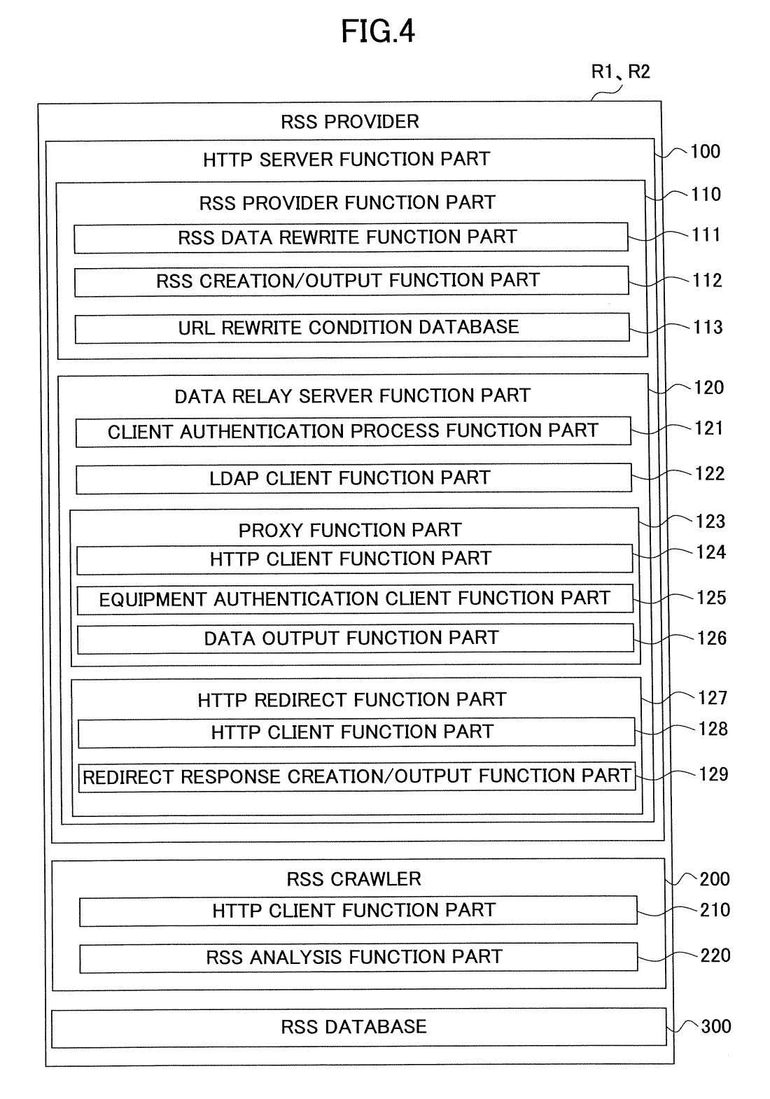

FIG. 4 is a block diagram of each of the RSS providers R1 and R2. As shown in FIG. 4, each of the RSS providers R1 and R2 includes an HTTP server function part 100 which offers HTTP (Hyper Text Transfer Protocol) service (reception of a request and return of a response) to the computer C1, an RSS crawler 200 which acquires RSS from the FAX terminal F1 or F2 or another RSS provider R2 or R1, and a database 300 which retains the acquired RSS.

The HTTP server function part 100 includes an RSS provider function part 110 which provides RSS to the computer C1 and a data relay server function part 120 which provides facsimile reception image data to the computer C1.

The RSS provider function part 110 includes an RSS data rewrite function part 111 which rewrites the data of RSS acquired from the FAX terminal F1 or F2 or another RSS provider R2 or R1, an RSS creation/output function part 112 which creates formal RSS from the RSS of which data has been rewritten and outputs the created RSS to the computer C1, and a URL rewrite condition database 113 which retains rewrite conditions of the data.

The data relay server function part 120 includes a client authentication process function part 121 which authenticates the user of the computer C1 or equipments by the LDAP server L1, an LDAP client function part 122 which requests authentication to the LDAP server L1, a proxy function part 123 which acts for acquisition of data from the FAX terminal F1 or F2 or another RSS provider R2 or R1, and an HTTP redirect function part 127 which redirects an accessing point so that data can be acquired directly from the FAX terminal F1 or F2 or another RSS provider R2 or R1 by the computer C1.

The proxy function part 123 includes an HTTP client function part 124 which makes a connection to the FAX terminal F1 or F2 or another RSS provider R2 or R1, an equipment authentication client function part 125 which performs equipment authentication between the FAX terminal F1 or F2 or another RSS provider R2 or R1, and a data output function part 126 which outputs data to the computer C1.

The HTTP redirect function part 127 includes an HTTP client function part 128 which requests and acquires a one time password from the FAX terminal F1 or F2 or another RSS provider R2 or R1, and a redirect response creation/output function part 129 which creates and outputs a redirect response for requesting HTTP redirect to the computer C1.

The RSS crawler 200 includes an HTTP client function part 210 which makes a connection to the FAX terminal F1 or F2 or another RSS provider R2 or R1, and an RSS analysis function part 220 which analyzes acquired RSS.

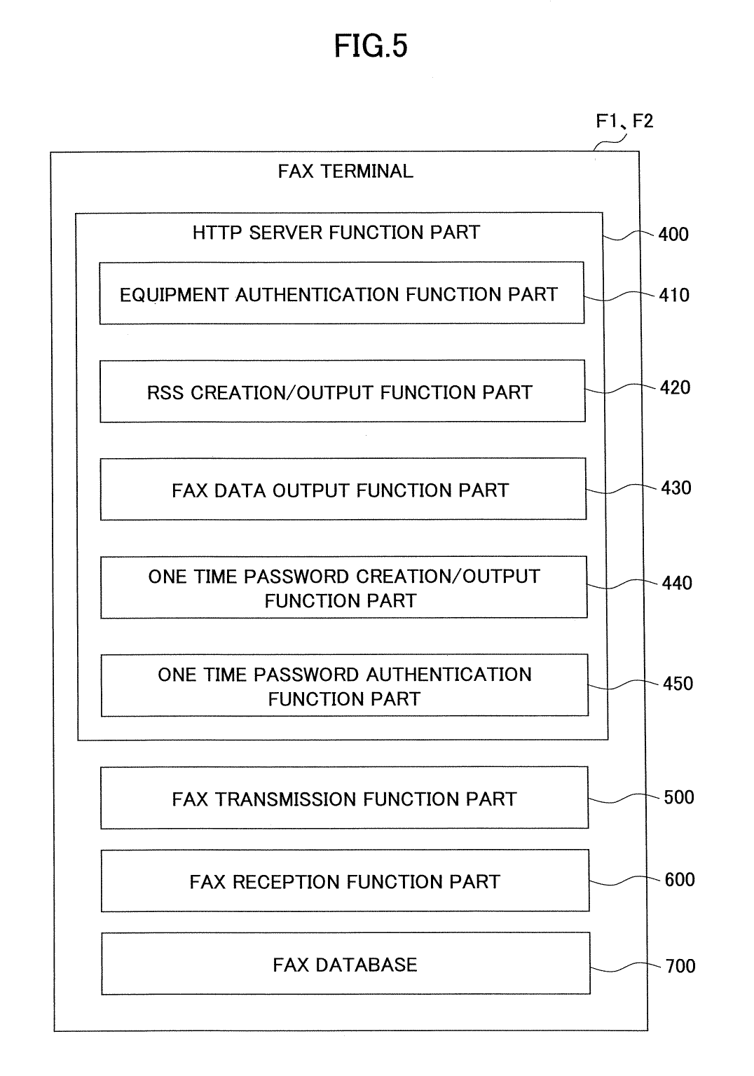

FIG. 5 is a block diagram of each of the FAX terminals F1 and F2. As shown in FIG. 5, each of the FAX terminals F1 and F2 includes an HTTP server function part 400 which offers HTTP service to the RSS providers R1 and R2, a FAX transmission function part 500 which performs transmission of facsimile, a FAX reception function part 600 which performs reception of facsimile, and a FAX database 700 which retains transmitted and received facsimile data.

The HTTP server function part 400 includes an equipment authentication function part 410 which performs equipment authentication between the RSS provider R1 or R2 requesting a connection, an RSS creation/output function part 420 which creates RSS and outputs the created RSS, a facsimile data output function part 430 which outputs facsimile data, a one time password creation/output function part 440 which creates a one time password as access right certificate information when directly connecting from the computer C1 and outputs the created one time password, and a one time password authentication function part 450 which authenticates the one time password.

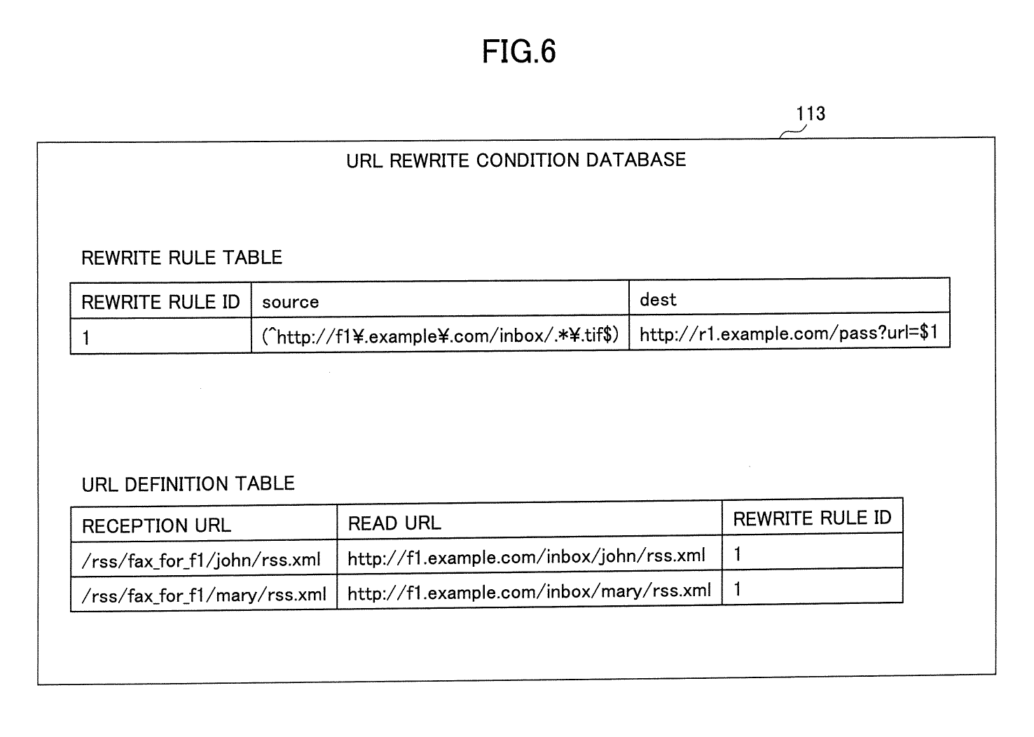

FIG. 6 is an illustration of an example of the URL rewrite condition database 113 in the RSS providers R1 and R2. In the URL rewrite condition database 113, there is defined which rewrite is performed with respect to URL contained in the link element of RSS received from the FAX terminal F1 or F2 or another RSS provider R2 or R1. The URL rewrite condition database 113 is comprised of a rewrite rule table and a URL definition table.

The rewrite rule table shown in FIG. 6 is an example of the rewrite rule created to be applied to RSS regarding facsimile received by the FAX terminal F1. The “source” column describes the URL which is an object to be rewritten by using regular expression and indicates one corresponding URL belong to “http://fl.example.com/inbox/” and having an extension of tif. The “dest” column indicates URL after rewritten. $1 in the “dest” column is substituted by a character string matching a parenthesized item in the “source” column.

The URL definition table shown in FIG. 6 is an example which defines the FAX reception history reading URL addressed to “john” and “mary” reached to the FAX terminal F1 and rewrite rule ID.

<Basic Operation>

FIG. 7 is a sequence chart showing an example of a process of the system. A description will be given below of an operation when reviewing facsimile received by the FAX terminal F1 from the computer C1 through the RSS provider R1.

(Acquiring RSS)

The computer C1 sends a request for RSS acquisition to the RSS provider function part 110 of the RSS provider R1 (step S101). There is no need to send authentication information from the computer C1 when acquiring RSS.

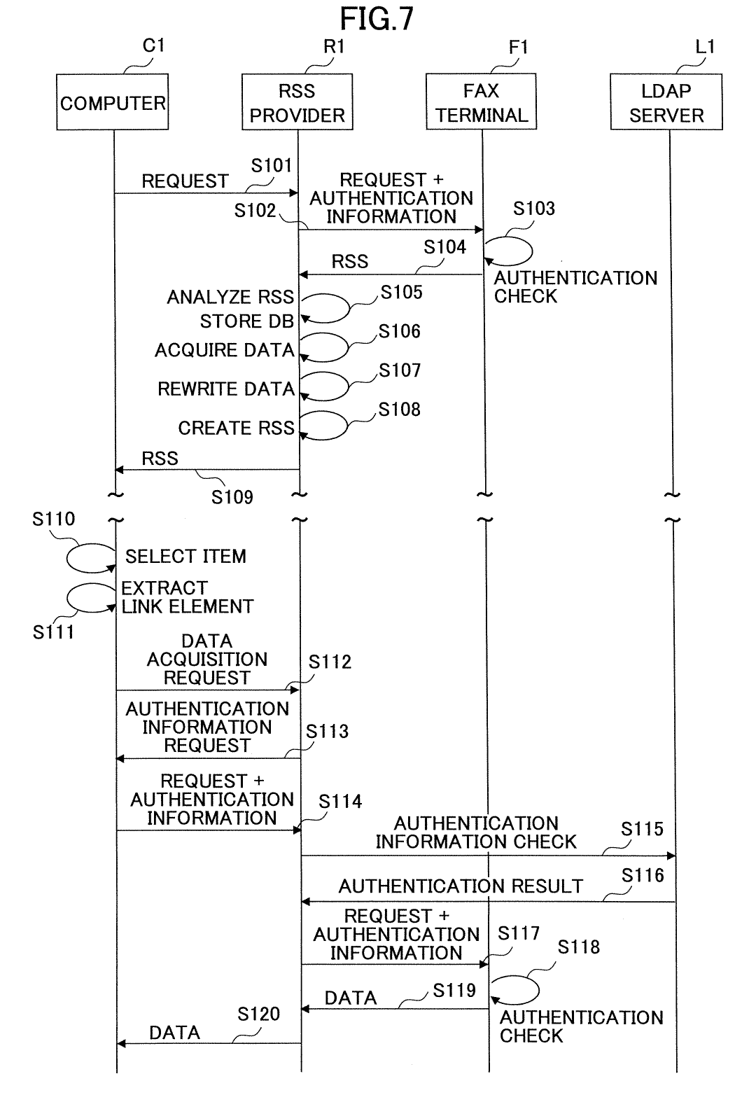

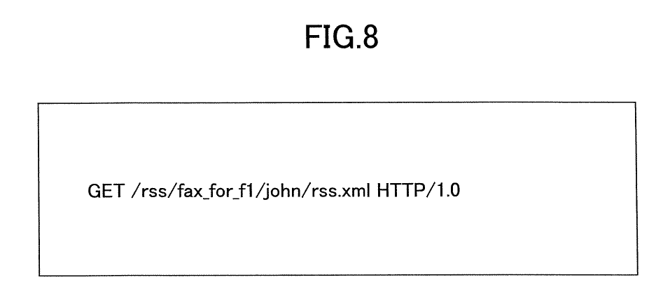

FIG. 8 is an illustration showing an example of a request for acquiring RSS. A request “GET/rss/fax_for_f1/john/rss.xml HTTP/1.0” is transmitted to URL “http://r1.example.com/rss/fax_for_f1/john/rss.xml” of the RSS provider R1 (r1.example.com) in order to acquire RSS previously set by a manager as facsimile reception history of “john” of the FAX terminal F1 (f1.example.com). It should be noted that although the example of HTTP was explained, encrypted HTTP (https) encrypted by SSL (Source Socket Layer) communication may be used instead of HTTP.

Returning to FIG. 7, the HTTP client function part 210 of the RSS provider R1 transmits to the FAX terminal F1 a request for acquiring RSS and authentication information peculiar to the RSS provider R1 (step S102). The equipment authentication function part 410 of the FAX terminal F1 checks the authentication information peculiar to the RSS provider R1 (step S103). If the check results in failure, the equipment authentication function part 410 notifies the RSS provider R1 of the fact and the RSS provider R1 rejects the request. On the other hand, the check results in success, the RSS creation/output function part 420 of the FAX terminal F1 outputs RSS to the RSS provider R1 (step S104). Then, the RSS analysis function part 220 of the RSS provider R1 analyzes the RSS, and stores it in the RSS database 300 (step S105).

The RSS provider function part 110 of the RSS provider R1 acquires data from the RSS database 300 (step S106). The RSS data rewrite function part 111 rewrites data corresponding to the link element of the RSS contained in the date retrieved from the RSS database 300 in accordance with the URL rewrite condition database 113 (step S107). The RSS creation/output function part 112 of the RSS provider R1 creates RSS (step S108), and outputs the created RSS to the computer C1 (step S109).

From the acquisition of RSS and the creation and output of RSS are performed in the following manner.

(1) When the computer C1 requests URL “http://r1.example.com/rss/fax_for_f1/john/rss.xml” of the RSS provider R1, the RSS provider function part 110 of the RSS provider R1 searches the reception URL column of the URL definition table (FIG. 6), and determines what requests the reception history corresponding to “john” of the FAX terminal F1.

(2) The RSS provider R1 acquires RSS from URL “http://f1.example.com/inbox/john/rss.xml” of the FAX terminal F1 written in the read URL column of the URL definition table, and analyzes the acquired RSS and stores the result of the analysis in the RSS database 300.

(3) The RSS provider function part 110 performs rewriting according to the rule of the rewrite rule ID=1 with respect to the link element while reading data from the RSS database 300.

(4) The RSS creation/output function part 112 rearrange the result in the form of RSS, and outputs it to the computer C1.

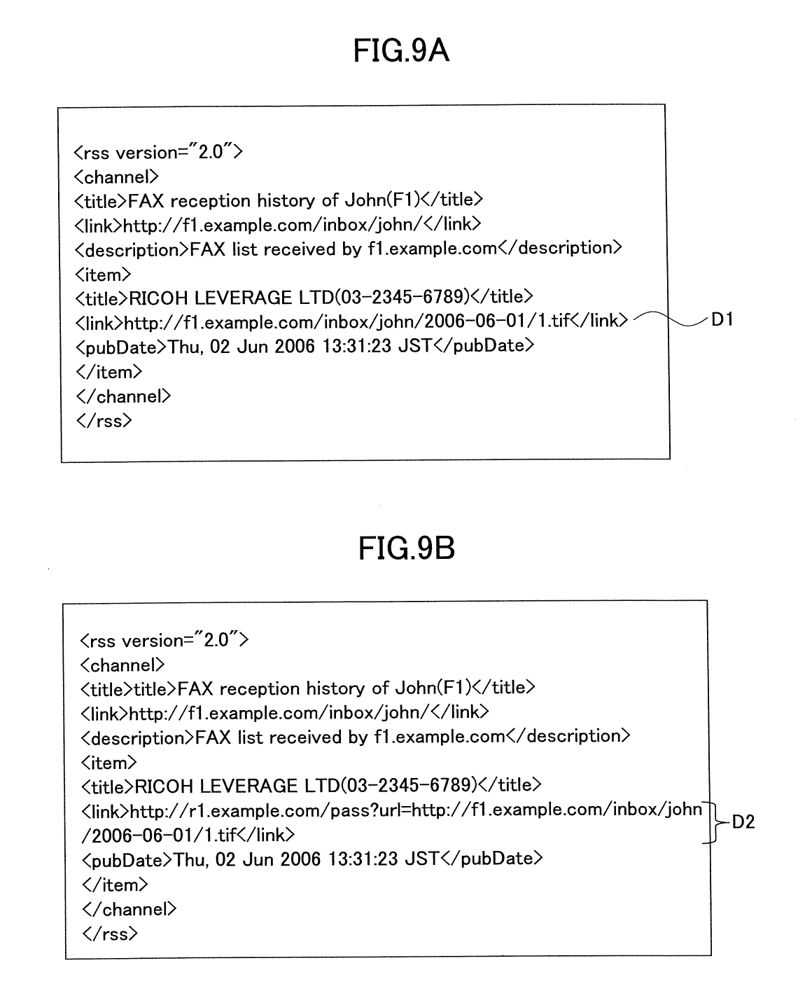

FIG. 9A is an illustration showing the RSS before the rewriting, and FIG. 9B is an illustration showing the RSS after the rewriting. It is appreciated that the description D1 “<link>http://f1.example.com/inbox/john/2006-06-01/1.tif</link>” directly under the item element in the RSS before rewritten shown in FIG. 9A is rewritten to the description D2 “<link>http://r1.example.com/pass?url=http://f1.example. com/inbox/john/2006-06-01/1.tif</link>” as shown in FIG. 9A.

(Acquiring Data)

In FIG. 7, the user selects a target item on the screen of the computer C1 displaying facsimile receiving history (step S110). The computer C1 extracts the link element of that item (step S111), and sends a request for data acquisition to the data relay server function part 120 of the RSS provider R1 according to URL written in the link element (step S112). The data relay server function part 120 of the RSS provider R1 sends a response indicating the need of authentication for data acquisition to the computer C1 (step S113). Then, the computer C1 sends to the data relay server function part 120 a request for data acquisition by attaching authentication information (step S114).

The client authentication process function part 121 of the RSS provider R1 checks authentication information with the LDAP server L1 through the LDAP client function part 122 (step S115), and obtains the result of the authentication (step S116). If the check results in failure, the RSS provider R1 notifies the computer C1 of the fact of the failure. On the other hand, if the check results in success (OK), the HTTP client function part 124 of the RSS provider R1 sends to the FAX terminal F1 a request for data acquisition and authentication information peculiar to the RSS provider R1 (step S117).

The facsimile terminal F1 checks the authentication information peculiar to the RSS provider R1 (step S118). If the check results in failure, the FAX terminal F1 notifies the RSS provider R1 of the fact, and the RSS provider R1 notifies the computer C1 of the authentication failure. On the other hand, if the check results in success (OK), the FAX terminal F1 outputs the corresponding facsimile image data to the HTTP client function part 124 of the RSS provider R1 (step S119). Then, the data relay server function part 120 of the RSS provider R1 outputs the data of the corresponding facsimile image data to the computer C1 (step S120).

<Variation 1>

According to a variation 1, the RSS provider R1 can acquire RSS from a plurality of FAX terminals F1 and F2 simultaneously. RSS which the RSS provider R1 provides to the computer C1 contains sets of information of the FAX terminals F1 and F2 sorted in order of time (in order of values obtained by interpreting the contents of the pubDate element.

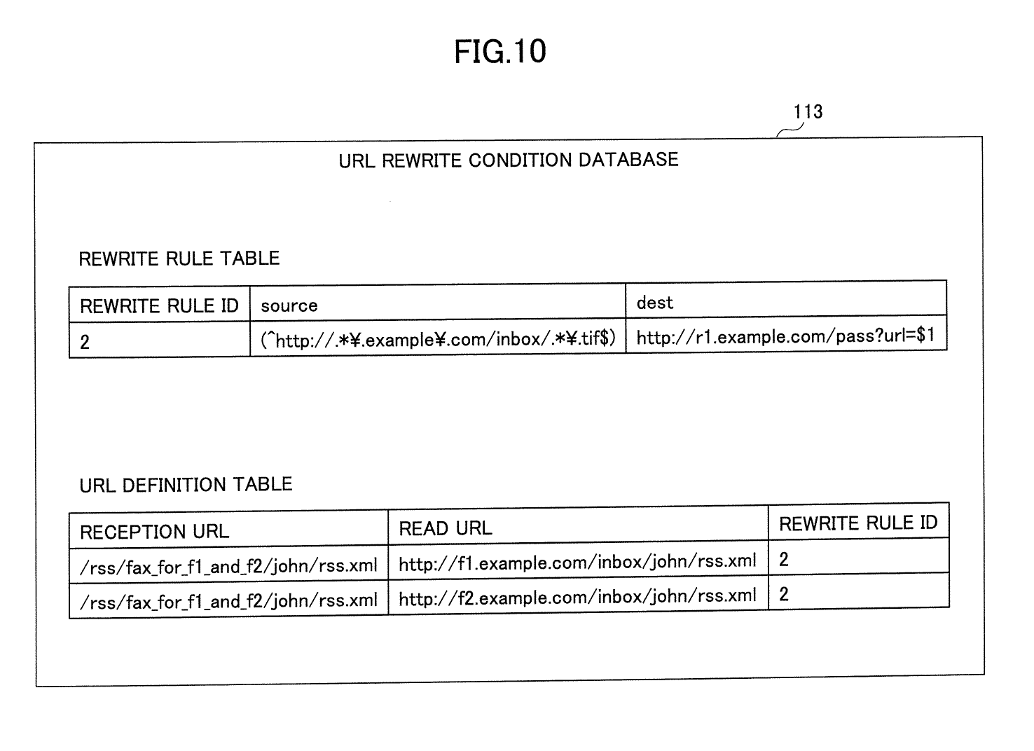

FIG. 10 is an illustration showing the URL rewrite condition database 113 in the variation 1. The rewrite rule table is arranged to be capable of corresponding to a plurality of FAX terminals F1 and F2 by setting the source column to “(̂http://.*¥.example¥.com/inbox/.*¥.tif$)”. Additionally, The URL definition table defines URL for the RSS containing reception history of facsimile addressed to “john” received by the FAX terminals F1 and F2. In order to output the RSS acquired from the two FAX terminals F1 and F2 as one RSS, two entries are defined for the same URL.

The entire process is the same as that shown in FIG. 7. From acquisition of RSS to creation and output of RSS are performed as follows.

(1) When the computer C1 requests RSS to “http://r1.example.com/rss/fax_for_f1_and_f2/john/rss.xm 1” of the RSS provider R1, the RSS provider function part 110 of the RSS provider R1 searches the reception URL column of the URL definition table (FIG. 10), and determines that reception history with respect to “john” of the FAX terminals F1 and F2 is requested.

(2) The RSS provider R1 acquires RSS from two URLs, “http://f1.example.com/inbox/john/rss.xml” and “http://f2.example.com/inbox/john/rss.xml”, of the FAX terminals F1 and F2 written in the read URL column of the URL definition table by using the RSS crawler 200, and analyzes the RSS and stores the result of the analysis in the RSS database 300.

(3) The RSS provider function part 110 reads data from the RSS database 300. At this time, it is rearranged according to the date and time of reception (in this example, it is provided by pubDate), and a predetermined number of histories from the latest one are retrieved. The RSS database 300 stores sets of data from the FAX terminals F1 and F2. Those sets of data are read from the list sequentially from the latest one.

(4) Perform rewriting with respect to the link element of the read data according to the rewrite rule ID=2.

(5) The RSS creation/output function part 112 rearranges the result in the form of RSS, and outputs it to the computer C1.

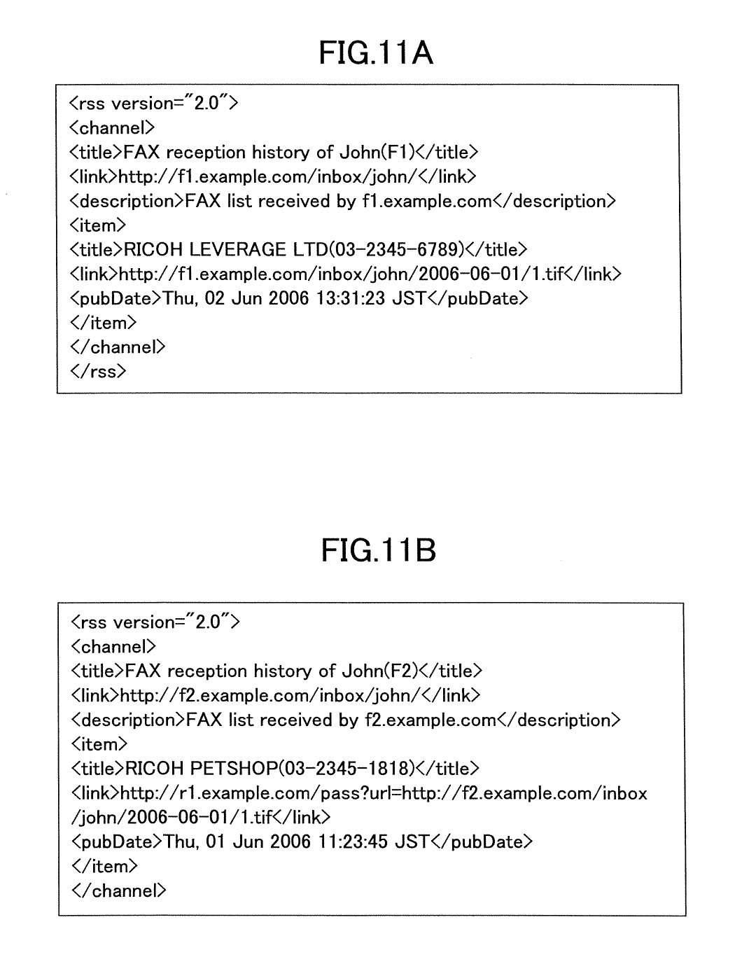

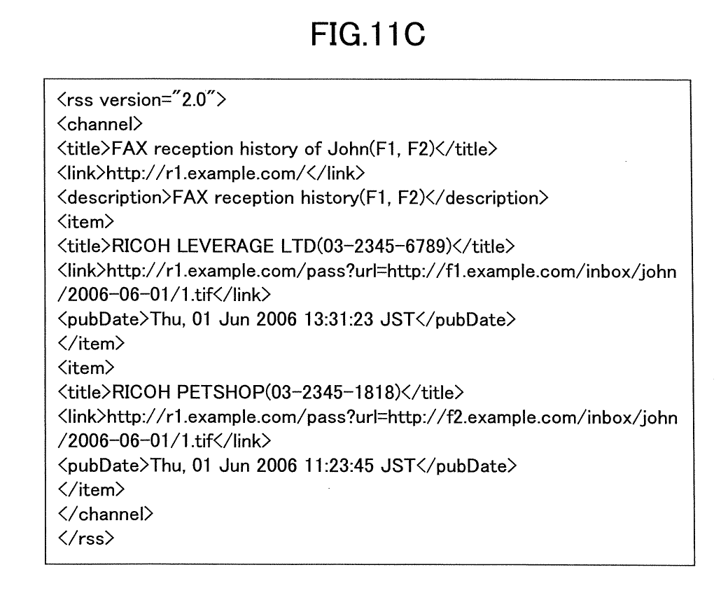

FIGS. 11A, 11B and 11C are illustrations showing an example of RSS before and after rewriting in the variation 1. FIG. 11A shows RSS acquired from the FAX terminal F1 and before rewriting. FIG. 11B shows RSS acquired from the FAX terminal F2 and before rewriting. FIG. 11C shows RSS after combining those RSSs (sorted in order of time) and after rewriting.

<Variation 2>

According to a variation 2, RSS is acquired beforehand when relaying RSS. When performing data acquisition after receiving a request for RSS, it takes a considerable time until output it in a case such that read is performed on many equipments. However, by separating crawl and RSS output temporally, the RSS output can be performed in a short period of time.

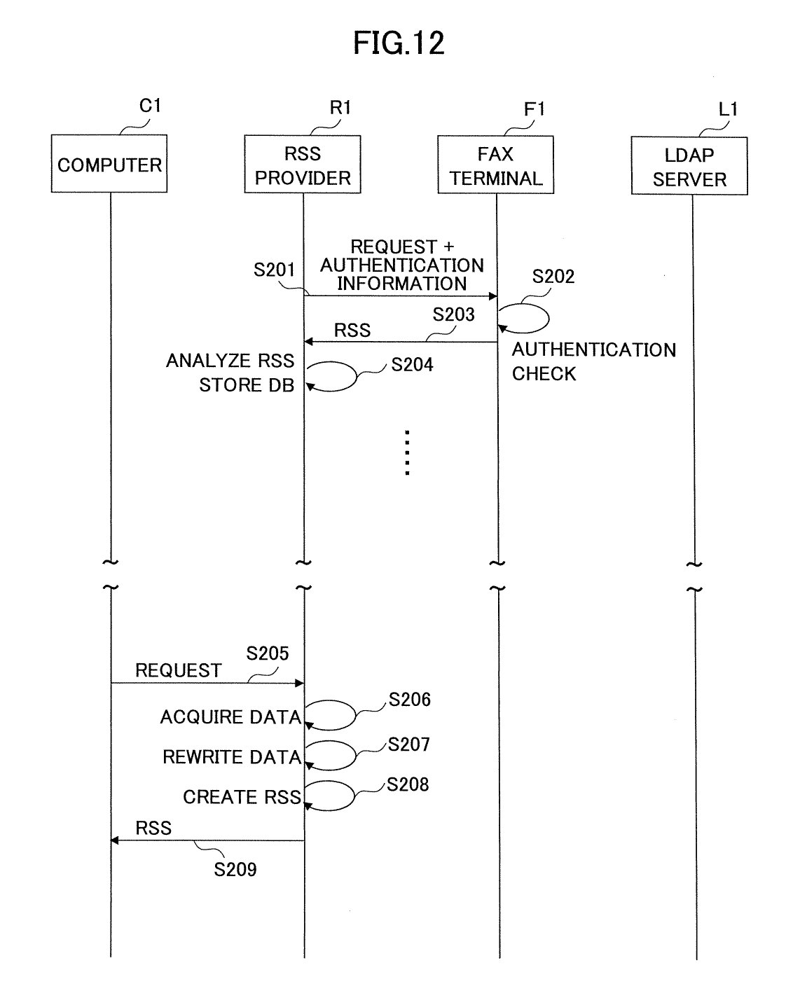

FIG. 12 is a sequence chart showing an example of a process of the system according to the variation 2.

(Crawl Operation)

In FIG. 12, the HTTP client function part 210 f the RSS provider R1 sends to the FAX terminal F1 a request for acquiring RSS and authentication information peculiar to the RSS provider R1 at a constant interval (for example, time interval of 10 minutes (step S201). The equipment authentication function part 410 of the FAX terminal F1 checks the authentication information peculiar to the RSS provider R1 (step S202). After the check, the RSS creation/output function part 420 of the FAX terminal F1 outputs the RSS to the RSS provider R1 (step S203). The RSS analysis function part 220 of the RSS provider R1 analyzes the RSS, and stores it in the RSS database 300 (step S204).

(RSS Output Operation)

The computer C1 sends a request to the RSS provider function part 110 of the RSS provider R1 at an arbitrary timing (step S205). The RSS provider function part 110 of the RSS provider R1 acquires data from the RSS database 300 (step S206). Then, the RSS data rewrite function part 111 of the RSS provider R1 rewrites data corresponding to the link element of the RSS contained in the previously retrieved data (step S207). The RSS creation/output function part 112 of the RSS provider R1 creates RSS (step S208), and outputs it to the computer C1 (step S209).

<Variation 3>

According to a variation 3, an access from the computer 1 is not relayed but redirected. In the basic invention, when the computer C1 requests data to the RSS provider R1, the RSS provider R1 acquires the data from the FAX terminal F1, and, then, provides the acquired data to the computer C1. According to this method, if a number of computers (C1, C2, C3, . . . ) is increased, a large load is applied to the RSS provider R1 and communication between the RSS provider and the FAX terminal F1. Thus, in the variation 3, an access by the computer C1 is not relayed but redirected.

At this time, it is arranged that the RSS provider R1 introduces the computer C1 to the FAX terminal F1, and a one time password is used for it. However, it is needed for the FAX terminal F1 to permit the access by the computer C1 upon introduction of the RSS provider R1. Thus, there is needed an agreement between the RSS provider and the FAX terminal F1. Since the FAX terminal F1 does not directly relates to the authentication of the computer C1, the FAX terminal F1 is not influenced even if the authentication scheme of the computer C1 is changed. It should be noted that the one time password is not an essential part of the present invention, and any methods may be used if the RSS provider R1 can introduce the computer C1 to the FAX terminal F1.

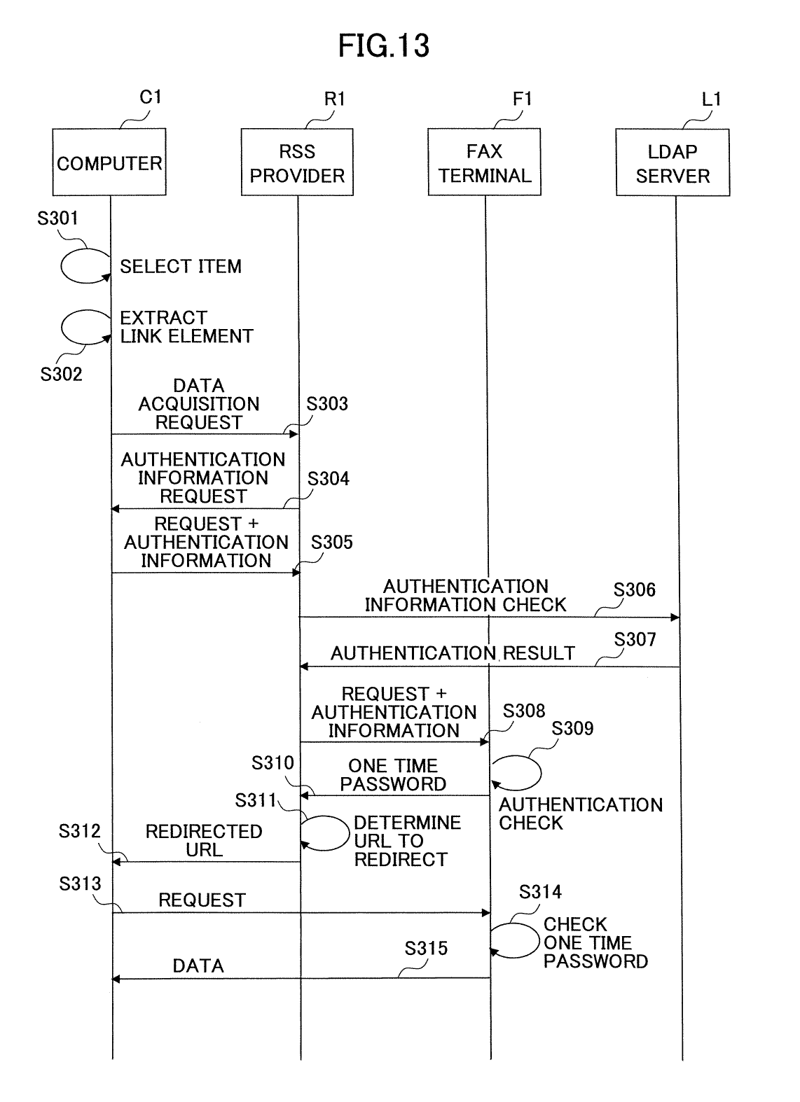

FIG. 13 is a sequence chart of an example of a process of the system in the variation 3.

(Acquiring Data)

The user selects a target item on the screen of the computer C1 displaying facsimile receiving history (step S301). The computer C1 extracts the link element of that item (step S302), and sends a request for data acquisition to the data relay server function part 120 of the RSS provider R1 according to URL written in the link element (step S303). The data relay server function part 120 of the RSS provider R1 sends a response indicating the need of authentication for data acquisition to the computer C1 (step S304). Then, the computer C1 sends to the data relay server function part 120 a request for data acquisition by attaching authentication information (step S305).

The client authentication process function part 121 of the RSS provider R1 checks authentication information with the LDAP server L1 through the LDAP client function part 122 (step S306), and obtains the result of the authentication (step S307). If the check results in failure, the RSS provider R1 notifies the computer C1 of the fact of the failure. On the other hand, if the check results in success (OK), the HTTP client function part 128 of the RSS provider R1 sends to the one time password creation/output function part 440 of the FAX terminal F1 a request for acquiring a one time password and authentication information peculiar to the RSS provider R1 (step S308).

The one time password creation/output function part 440 of the facsimile terminal F1 checks the authentication information of the RSS provider R1 (step S309). If the check results in failure, the FAX terminal F1 notifies the RSS provider R1 of the fact, and the RSS provider R1 notifies the computer C1 of the authentication failure. On the other hand, if the check results in success (OK), the FAX terminal F1 issues the one time password (step S310). Then, the redirect response creation/output function part 129 of the RSS provider R1 determines the redirected URL according to the request from the computer C1 and the one time password (step S311), and sends it to the computer C1 (step S312).

The HTTP server function part 400 of the FAX terminal F1 receives the request from the computer C1, and the one time password authentication function part 450 checks the one time password (step S314). If the check results in failure, the FAX terminal F1 notifies the computer C1 of the fact of failure. On the other hand, if the check results in success (OK), the FAX data output function part 430 of the FAX terminal F1 send the data to the computer C1 (step S315).

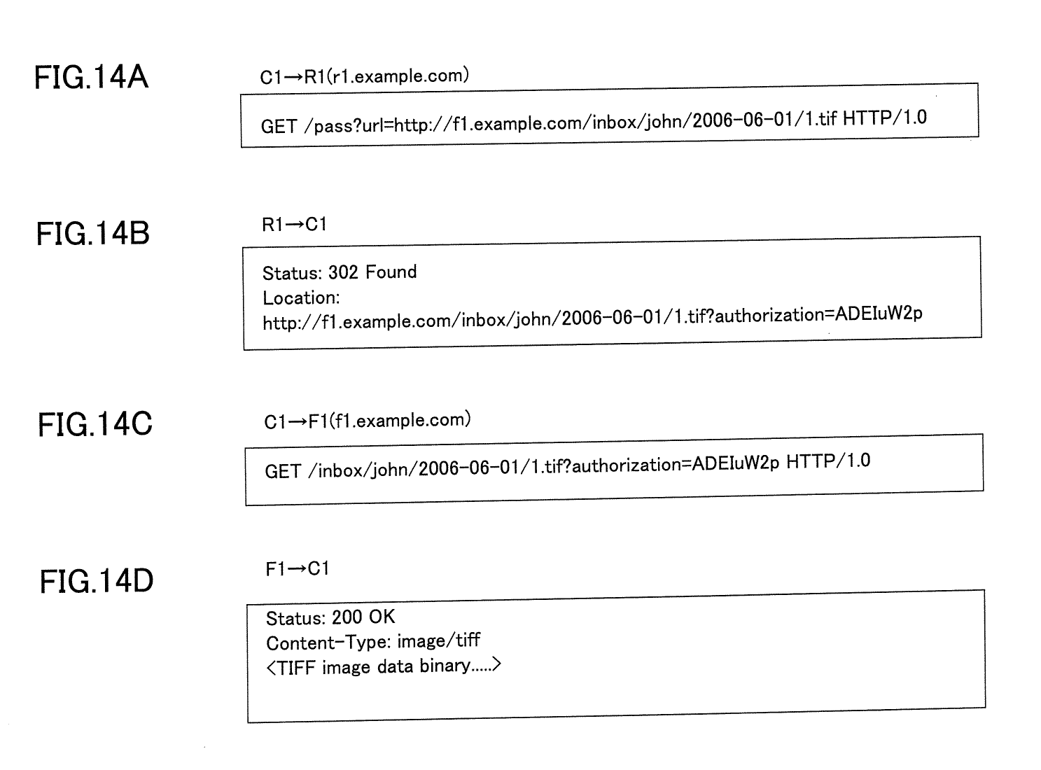

FIGS. 14A through 14D are illustrations showing contents of HTTP communication in the variation 3. FIG. 14A shows the request from the computer C1 to the RSS provider R1. FIG. 14B shows the response from the RSS provider R1 to the computer C1. FIG. 14C shows the request from the computer C1 to the FAX terminal F1. FIG. 14D shows the response from the FAX terminal F1 to the computer C1.

<Variation 4>

According to a variation 4, an access is not made from the computer C1 to the RSS provider R1, when acquiring data from the FAX terminals F1 and F2, but an access is made from the computer C1 to the authentication server A1 which intermediates the authentication process to the LDAP server L1. Thereby, it is only required to correspond the authentication server A1 to the LDAP server L1 when the LDAP server L1 is replaced due to a change in the authentication scheme, and, thus, operational reliability can be improved.

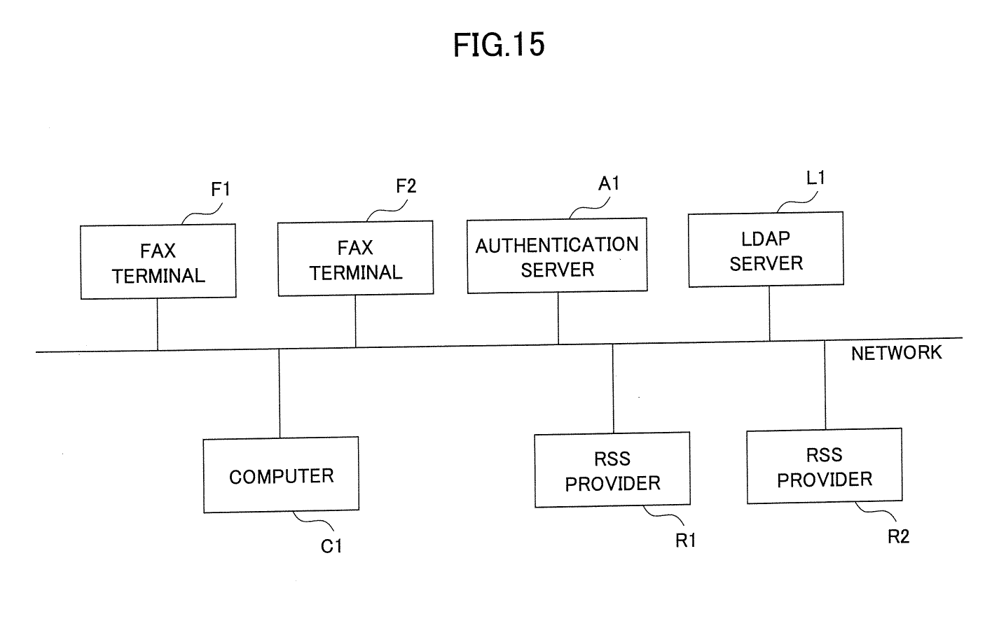

FIG. 15 is a block diagram of the system according to the variation 4. The system according to variation 4 has an authentication server A1 newly added to the network as compared to the system shown in FIG. 3.

As to the structure of the RSS providers R1 and R2, since there is no need to receive an access by the computer C1, it is not necessary to provide the data relay server function part 120 of the HTTP server function part 100 in each of the RSS providers R1 and R2 shown in FIG. 4.

Additionally, the dest column of the rewrite rule table in the URL rewrite condition database 113 of the RSS provider function part 110 shown in FIG. 4 is changed into, for example, “http://a1.example.com/pass?url=$1” having the address of the authentication server A1 from “http://r1.example.com/pass?url=$1” having the address of the RSS provider R1.

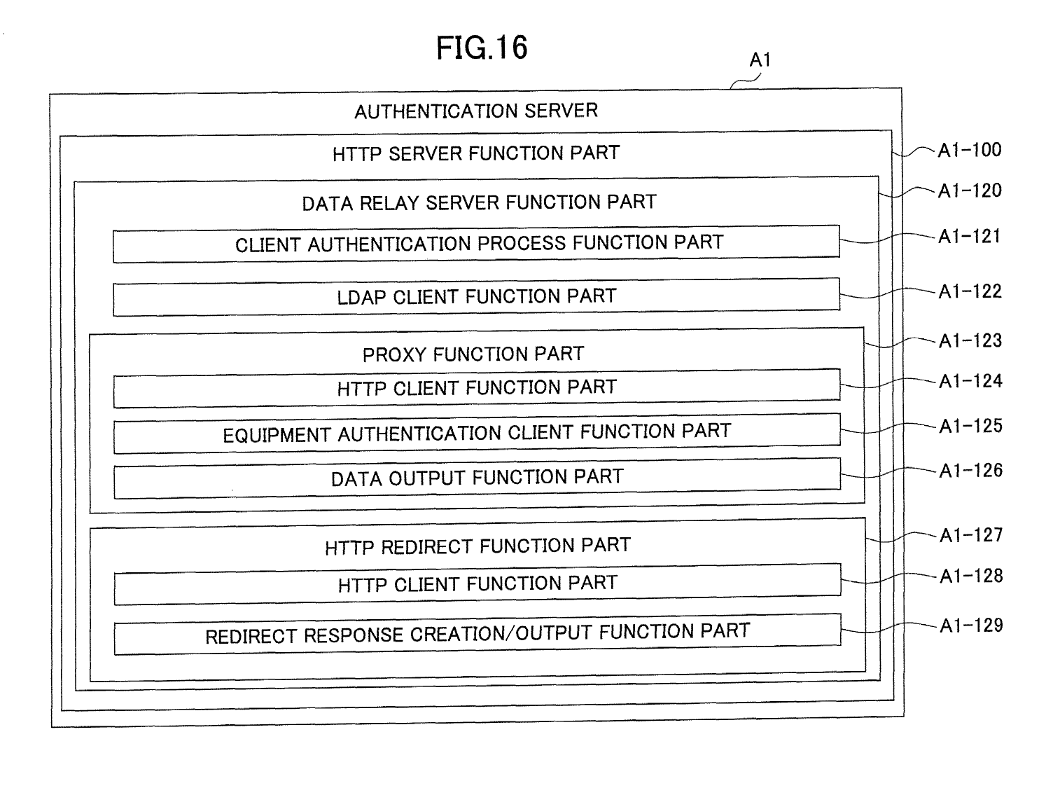

FIG. 16 is a block diagram of the authentication server A1 according to the variation 4. The authentication server A1 shown in FIG. 16 has a data relay server function part A1-120 of the HTTP server function part A1-100, which has the same structure as the structure of the data relay server 120 of the HTTP server function part 100 in the structure of each of the RSS providers R1 and R2 shown in FIG. 4. That is, the authentication server A1 includes an HTTP server function part A1-100 which provides HTTP service (reception of a request and return of a response) to the computer C1. The HTTP server function part A1-100 includes the data relay server function part A1-120 which provides facsimile reception image data to the computer C1.

The data relay server function part A1-120 includes a client authentication process function part A1-121 which authenticates the user of the computer C1 or the equipment by the LDAP server L1, an LDAP client function part A1-122 which requests authentication to the LDAP server L1, a proxy function part A1-123 which acts for data acquisition from the FAX terminal F1 or F2 or another RSS provider R2 or R1, and an HTTP redirect function part A1-127 which redirects an access so that the computer C1 can directly acquire data from the FAX terminal F1 or F2 or another RSS provider R2 or R1.

The proxy function part A1-123 includes an HTTP client function part A1-124 which connects to the FAX terminal F1 or F2 or another RSS provider R2 or R1, an equipment authentication client function part A1-125 which performs equipment authentication between the FAX terminal F1 or F2 or another RSS provider R2 or R1, and a data output function part A1-126 which outputs data to the computer C1.

The HTTP redirect function part A1-127 includes an HTTP client function part A1-128 which requests and acquires a one time password to the FAX terminal F1 or F2 or another RSS provider R2 or R1, and a redirect response creation/output function part A1-129 which creates and outputs a redirect response for requesting HTTP redirect to the computer C1.

As an operation at the time of acquiring RSS, it is different in that the data corresponding to the link element of RSS is rewritten to one having the address of the authentication server A1 in the data rewrite process of FIG. 7 and FIG. 12 (step S107 of FIG. 7 and step S207 of step S12).

As an operation at the time of acquiring data, it is different in that the process intermediated by the RSS provider R1 in FIG. 7 and FIG. 13 (steps S112-S177, S119 and S120, steps S303-S308 and S310-S312 of FIG. 13) are replaced by a process intermediated by the authentication server A1.

<Variation 5>

According to a variation 5, when creating RSS, the FAX terminals F1 and F2 having the RSS output function create the RSS with the link element which addresses to not itself but the authentication server A1. Although it is not applicable to all of existing FAX terminals, it can be applied to a case where data written in the link element of RSS can be designated by setting.

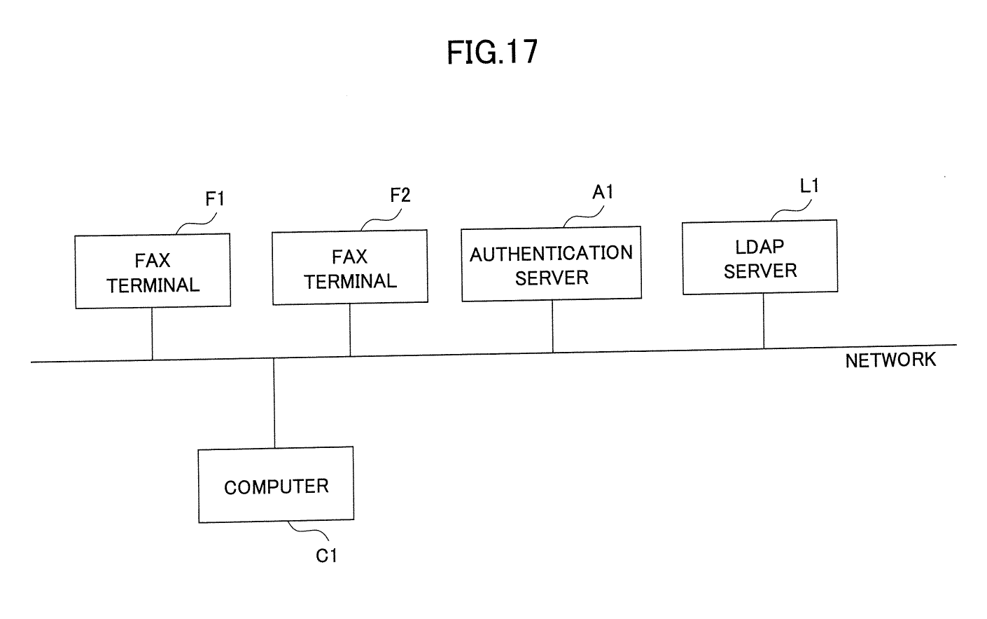

FIG. 17 is a block diagram of a system according to the variation 5. In the system shown in FIG. 17, the RSS providers R1 and R2 are removed as compared to the system shown in FIG. 15.

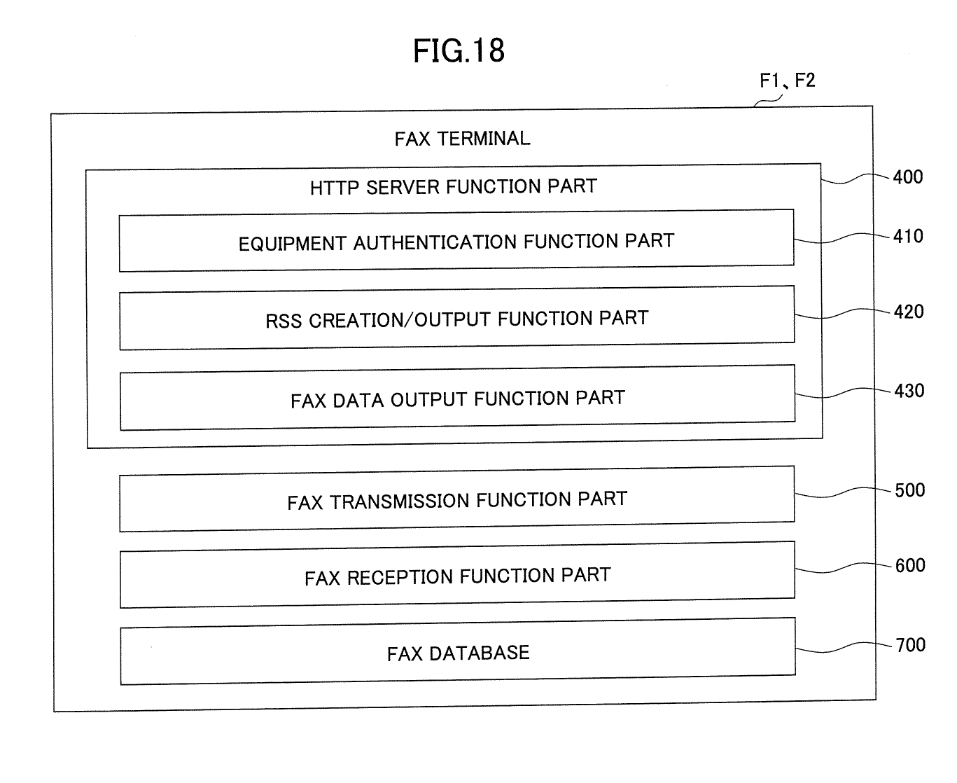

FIG. 18 is a block diagram of each of the FAX terminals F1 and F2 according to the variation 5. Since the RSS providers R1 and R2 are not needed, the one time password creation/output function part 440 and the one time password authentication function part 450 are removed from the structural elements of the FAX terminals F1 and F2 shown in FIG. 5. It should be noted that the equipment authentication function part 410 remains since it is necessary to perform equipment authentication between the authentication server A1.

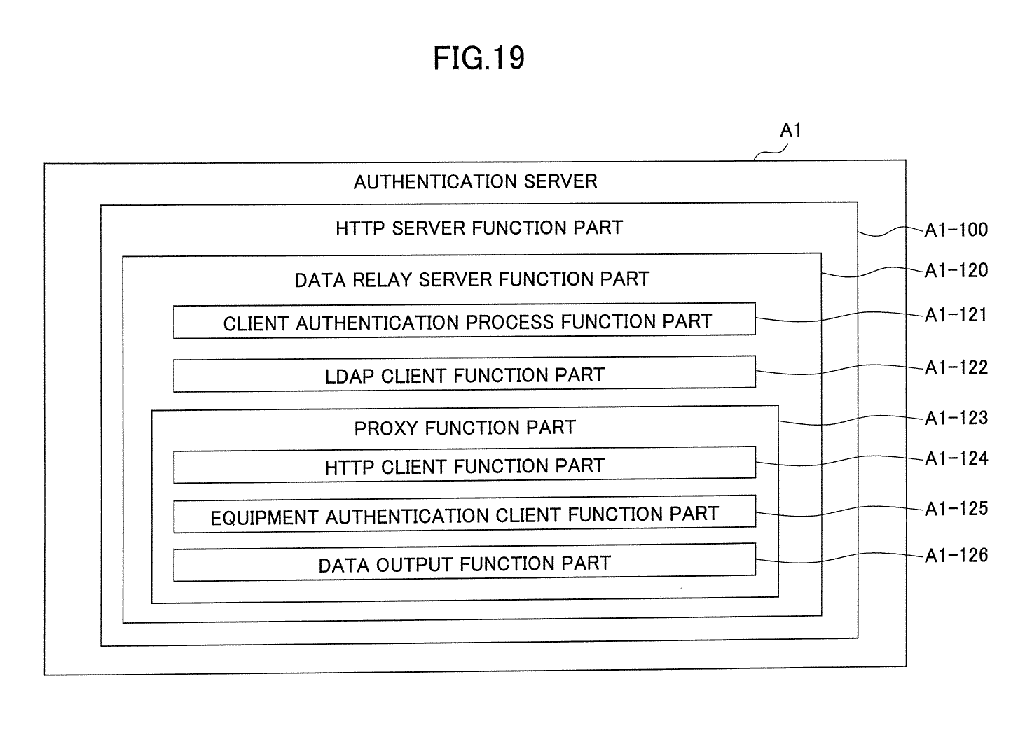

FIG. 19 is a block diagram of the authentication server A1 according to the variation 5. In the authentication server A1 shown in FIG. 19, the HTTP redirect function part A1-127 is removed from the structural elements of the authentication server A1 shown in FIG. 16.

As to an operation when acquiring RSS, the process (steps S101-S109) intermediated by the RSS provider R1 and the FAX terminal F1 is replaced by a process by the FAX terminal F1. Thus, the process (steps S102 and S103) is not needed, and the process from acquisition of RSS to rewrite of data (steps S104-S107) is not needed. Additionally, it is different in that the data corresponding to the link element of RSS is created to be addressed to the authentication server A1 in the process (step S108) of creating RSS.

As to an operation when acquiring data, it is different in that the process (steps S112-S11, S119 and S120) intermediated by the RSS provider R1 in FIG. 7 is replaced by a process intermediated by the authentication server A1.

<Variation 6>

In a variation 6, the present invention is applied to the FAX terminals F1 and F2 that do not have an RSS output function. In the variation 6, the RSS providers R1 and R2 acquire information of received facsimile from the FAX terminals F1 and F2, and create RSS and distribute the created RSS. Although it cannot be applied to all of existing FAX terminals that do not have an RSS output function, it can be applied to a case where the FAX terminal has a function to output facsimile information managed by itself according to an external communication function.

Although the system structure is the same as that shown in FIG. 3, communication between the RS providers R1 and R2 and the FAX terminals F1 and F2 should be communication by an exclusive interface which is not based on HTTP. Accordingly, there is no need to perform equipment authentication between the RSS providers R1 and R2 and the FAX terminals F1 and F2. It should be noted that the RSS providers R1 and R2 and the FAX terminals F1 and F2 may be directly connected by an exclusive communication cable instead of the network.

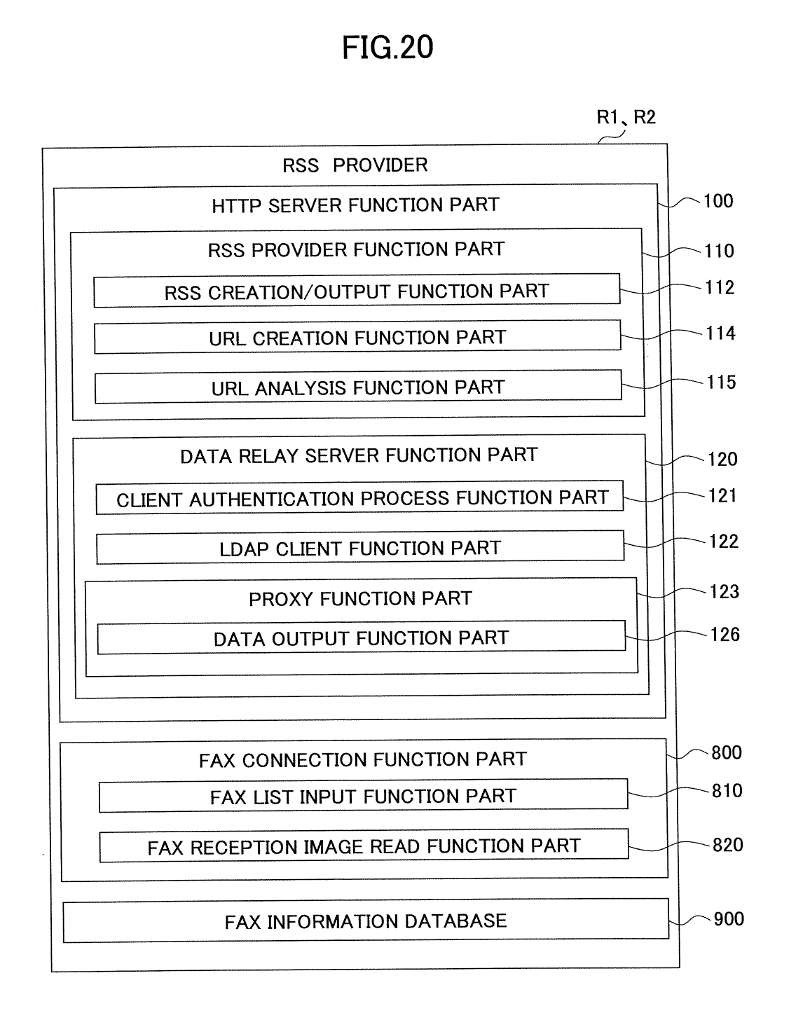

FIG. 20 is a block diagram of each of the RSS providers R1 and R2 according to the variation 6. Each of the RSS providers R1 and R2 has a structure in which the RSS data rewrite function part 111, the URL rewrite condition database 113, the HTTP client function part 124, the equipment authentication client function part 125, the HTTP redirect function part 127, RSS crawler 200, and the RSS database 300 are removed from the structural elements of each of the RSS providers R1 and R2 shown in FIG. 4. Instead, a URL creation function part 114 and a URL analysis function part 115 are added as shown in FIG. 20. The URL creation function part 114 creates URL (URL corresponding to a facsimile reception image) to be embedded in the link element of RSS within the RSS provider function part 110. The URL analysis function part 115 analyzes URL of the data acquisition request from the computer C1 so as to specify the corresponding facsimile reception image. Additionally, a FAX connection function part 800 is provided to perform communication through an interface exclusive for the FAX terminals F1 and F2. The FAX connection function part 800 includes a FAX list input function part 810 and a FAX reception image read function part 820. The FAX list input function part 810 inputs a FAX list (list data of facsimile reception image) from the FAX terminals F1 and F2. The FAX reception image read function part 820 reads facsimile reception images from the FAX terminals F1 and F2. Further, there is provided a FAX information database 900 which retains the information (the FAX list, etc.) acquired from the FAX terminals F1 and F2.

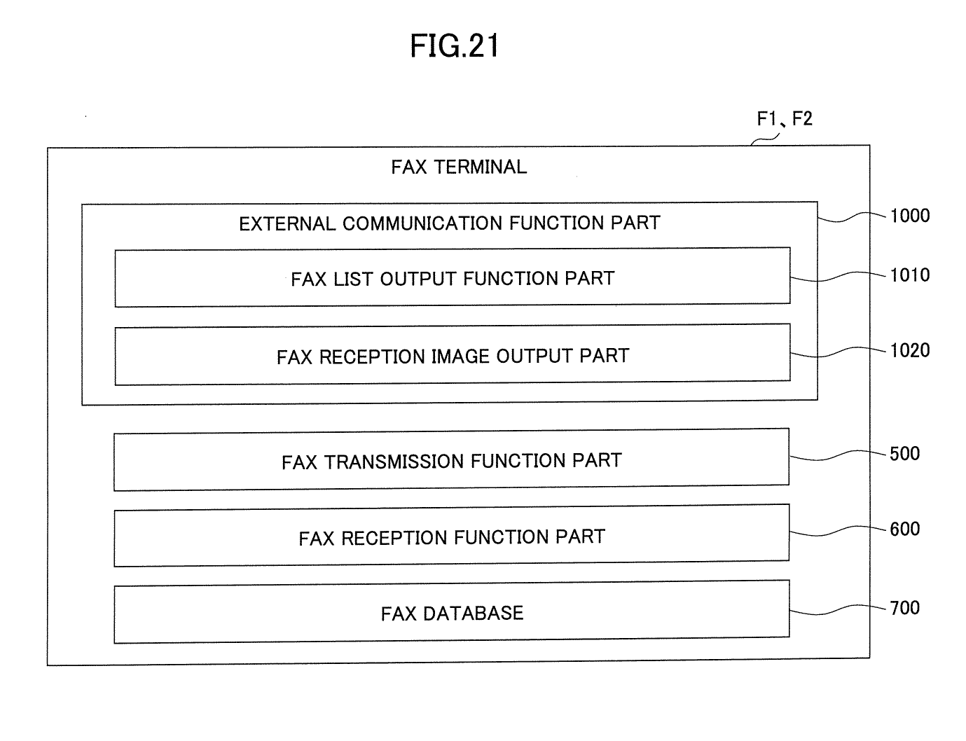

FIG. 21 is a block diagram of each of the FAX terminals F1 and F2 according to the variation 6. Each of the FAX terminals F1 and F2 according to the variation 6 has a structure in which the HTTP server function part 400 is removed from the structural elements of each of the FAX terminals F1 and F2, and, instead, an external communication function part 1000 is provided to perform communication through an interface exclusive for the RSS providers R1 and R2. The external communication function part 1000 is provided with a FAX list output function part 1010 which outputs the FAX list to the RSS providers R1 and R2 and a FAX reception image output function part 1020 which outputs FAX reception image to the RSS providers R1 and R2.

As an operation to acquire RSS, the process (steps S102-S104) of acquiring RSS from the FAX terminal F1 by the RSS provider R1 shown in FIG. 7 is replaced by a process performed by the exclusive interface which does not require equipment authentication. Additionally, the process (step S105) of analyzing RSS and storing in the database is replaced by a process of storing the FAX list acquired from the FAX terminal F1 in the FAX information database 900. Further, the process (step S107) of rewriting data becomes unnecessary, and is replaced by a process of creating RSS from the FAX list acquired from the FAX terminal F1 in the process (step S108) of creating RSS.

It should be noted that the FAX list contains items such as “sender”, “reception date and time”, “receiver”, “ID number”, etc, and the URL creation function part 114 of the RSS provider R1 creates URL that is not duplicate when acquiring facsimile image from the access URL of its own, identification information of the FAX terminal F1 and the information of the FAX list in the process (step S108) of creating RSS. This is because the FAX terminal F1 does not have an RSS output function and does not have URL for accessing the facsimile image.

As creation of URL, if, for example, the access URL of its own is “http://r1.example.com/fax/”, the identification information of the FAX terminal F1 is “fl”, the receiver is “john” and the ID number is “12345”, “http://r1.example.com/fax/f1/john/12345.tif” is created as URL. It should be noted that the portion of “.tif” at the end of the URL is added in accordance with a format of the image to be output for the sake of convenience of the computer C1.

As an operation when acquiring data, it is different in that the process (steps S117 to S119) of acquiring data from the FAX terminal F1 by the RSS provider in FIG. 7 is replaced by a process performed by the exclusive interface which does not require equipment authentication. It should be noted that when performing a request for designating a facsimile image (a request by the exclusive interface), the URL of the request (a request according to HTTP) from the computer C1 is analyzed so as to specify the ID number of the corresponding facsimile image. That is, if, for example, the URL is “http://r1.example.com/fax/f1/john/12345.tif”, the URL analysis function part 115 of the RSS provider R1 extracts the ID number “12345” and specifies the facsimile image.

<Summary>

As mentioned above, there is provided according to the above-mentioned embodiment and variations thereof an information providing system in which meta data (corresponding to RSS) described in structured language is distributed to a computer (corresponding to a use side apparatus) and main information is accessed by the computer based on a link element contained in the meta data. The information providing system includes: a meta data request receiving part that receives a request for acquiring meta data from the computer; a creating part that creates meta data having the link element of which destination is set to an authentication substitute processing part provided separately from a FAX terminal (corresponding to an information source apparatus) that manages information as an object of the meta data; a returning part that returns the created meta data to the computer (use side apparatus); an information request receiving part that receives a request for acquiring information based on the link element contained in the meta data from the computer; and a substitute authentication processing part that performs a substitute process of authentication for the computer in accordance with the received request for acquiring information, wherein the FAX terminal provides the main information to the computer when the authentication has been done normally.

As mentioned above, there are following advantages provided by the FAX terminal according to the above-mentioned embodiment of the present invention and the variations thereof.

(1) Since the authentication scheme is not required by an LDAP server or the like on the side of the FAX terminals F1 and F2, there is no need to replace the equipment itself even when the authentication scheme is changed.

(2) Since an authentication process is not required when acquiring RSS, software to be used is not limited, which promotes use of RSS.

(3) Since authentication is performed only at the time of access to URL contained in RSS acquired from equipments and data after processing the RSS, the system structure eliminating waste can be achieved.

The present invention is not limited to the specifically disclosed embodiments, and variations and modifications may be made without departing the scope of the present invention.

The present application is based on Japanese priority applications No. 2006-220145 filed Aug. 11, 2006 and No. 2007-197908 filed Jul. 30, 2007, the entire contents of which are hereby incorporated herein by reference.

What is claimed is:

1. An information access control method in a system in which meta data described in structured language is distributed to a use side apparatus and main information is accessed by said use side apparatus based on a link element contained in the meta data, the information access control method comprising:
receiving a request for acquiring meta data from said use side apparatus;
creating meta data having the link element of which destination is set to an authentication substitute processing apparatus provided separately from an information source apparatus that manages information as an object of the meta data;
returning the created meta data to said use side apparatus;
receiving a request for acquiring information based on the link element contained in the meta data from said use side apparatus;
performing a substitute process of authentication for said use side apparatus in accordance with the received request for acquiring information; and
providing the main information from said information source apparatus to said user side apparatus when the authentication has been done normally.

2. The information access control method as claimed in claim 1, wherein
a provider apparatus receives a request for acquiring the meta data from said use side apparatus;
said provider apparatus creates the meta data having the link element of which destination is set to the authentication substitute processing apparatus provided separately from the information source apparatus that manages information as an object of the meta data;
said provider apparatus returns the created meta data to said use side apparatus;
said provider apparatus receives a request for acquiring information based on the link element contained in the meta data from said use side apparatus;
said provider apparatus serving as said authentication substitute processing apparatus performs the substitute process of authentication of said use side apparatus in accordance with the received request for acquiring information; and
when the authentication has been done normally, the main information is provided from said information source apparatus to said use side apparatus upon an instruction from said provider apparatus.

3. The information access control method as claimed in claim 1, wherein
a provider apparatus receives a request for acquiring the meta data from said use side apparatus;
said provider apparatus creates the meta data having the link element of which destination is set to the authentication substitute processing apparatus provided separately from the information source apparatus that manages information as an object of the meta data;
said provider apparatus returns the created meta data to said use side apparatus;
said provider apparatus receives a request for acquiring information based on the link element contained in the meta data from said use side apparatus;
said authentication substitute processing apparatus performs the substitute process of authentication of said use side apparatus in accordance with the received request for acquiring information; and
when the authentication has been done normally, the main information is provided from said information source apparatus to said use side apparatus upon an instruction from said authentication substitute processing apparatus.

4. The information access control method as claimed in claim 1, wherein
said information source apparatus receives a request for acquiring the meta data from said use side apparatus;
said information source apparatus creates the meta data having the link element of which destination is set to the authentication substitute processing apparatus provided separately from the information source apparatus that manages information as an object of the meta data;
said information source apparatus returns the created meta data to said use side apparatus;
said information source apparatus receives a request for acquiring information based on the link element contained in the meta data from said use side apparatus;
said authentication substitute processing apparatus performs the substitute process of authentication of said use side apparatus in accordance with the received request for acquiring information; and
when the authentication has been done normally, the main information is provided from said information source apparatus to said use side apparatus upon an instruction from said authentication substitute processing apparatus.

5. The information access control method as claimed in claim 1, wherein
a provider apparatus receives a request for acquiring the meta data from said use side apparatus;
said provider apparatus creates the meta data having the link element of which destination is set to the authentication substitute processing apparatus provided separately from the information source apparatus that manages information as an object of the meta data;
said provider apparatus returns the created meta data to said use side apparatus;
said provider apparatus receives a request for acquiring information based on the link element contained in the meta data from said use side apparatus;
said provider apparatus serving as said authentication substitute processing apparatus performs the substitute process of authentication of said use side apparatus in accordance with the received request; and
when the authentication has been done normally, said provider apparatus acquires the main information from said information source apparatus and provides the acquired main information to said use side apparatus.

6. The information access control method as claimed in one of claims 2, 3 and 5, wherein said provider apparatus creates the meta data of which contents are sorted in an order of time based on information from a plurality of said information source apparatuses.

7. The information access control method as claimed in one of claims 2, 3 and 5, wherein said provider apparatus creates the meta data each time the request for acquiring information is received from said information source apparatus, or based on information that has been collected previously.

8. The information access control method as claimed in claim 2, wherein said provider apparatus provides the main information, in response to the request for acquiring information from said use side apparatus, through said provider apparatus itself, or by causing said information source apparatus to perform redirection.

9. The information access control method as claimed in claim 3, wherein said authentication substitute processing apparatus provides the main information, in response to the request for acquiring information from said use side apparatus, through said authentication substitute processing apparatus itself, or by causing said information source apparatus to perform redirection.

10. An information providing system in which meta data described in structured language is distributed to a use side apparatus and main information is accessed by said use side apparatus based on a link element contained in the meta data, the information providing system comprising:
a meta data request receiving part that receives a request for acquiring meta data from said use side apparatus;
a creating part that creates meta data having the link element of which destination is set to an authentication substitute processing apparatus provided separately from an information source apparatus that manages information as an object of the meta data;
a returning part that returns the created meta data to said use side apparatus;
an information request receiving part that receives a request for acquiring information based on the link element contained in the meta data from said use side apparatus; and
a substitute authentication processing part that performs a substitute process of authentication for said use side apparatus in accordance with the received request for acquiring information,
wherein said information source apparatus provides the main information to said user side apparatus when the authentication has been done normally.

11. The information providing system as claimed in claim 10, wherein
a provider apparatus receives a request for acquiring the meta data from said use side apparatus;
said provider apparatus creates the meta data having the link element of which destination is set to the authentication substitute processing apparatus provided separately from the information source apparatus that manages information as an object of the meta data;
said provider apparatus returns the created meta data to said use side apparatus;
said provider apparatus receives a request for acquiring information based on the link element contained in the meta data from said use side apparatus;
said provider apparatus serving as said authentication substitute processing apparatus performs the substitute process of authentication of said use side apparatus in accordance with the received request for acquiring information; and
when the authentication has been done normally, the main information is provided from said information source apparatus to said use side apparatus upon an instruction from said provider apparatus.

12. The information providing system as claimed in claim 10, wherein
a provider apparatus receives a request for acquiring the meta data from said use side apparatus;
said provider apparatus creates the meta data having the link element of which destination is set to the authentication substitute processing apparatus provided separately from the information source apparatus that manages information as an object of the meta data;
said provider apparatus returns the created meta data to said use side apparatus;
said provider apparatus receives a request for acquiring information based on the link element contained in the meta data from said use side apparatus;
said authentication substitute processing apparatus performs the substitute process of authentication of said use side apparatus in accordance with the received request for acquiring information; and
when the authentication has been done normally, the main information is provided from said information source apparatus to said use side apparatus upon an instruction from said authentication substitute processing apparatus.

13. The information providing system as claimed in claim 10, wherein
said information source apparatus receives a request for acquiring the meta data from said use side apparatus;
said information source apparatus creates the meta data having the link element of which destination is set to the authentication substitute processing apparatus provided separately from the information source apparatus that manages information as an object of the meta data;
said information source apparatus returns the created meta data to said use side apparatus;
said information source apparatus receives a request for acquiring information based on the link element contained in the meta data from said use side apparatus;
said authentication substitute processing apparatus performs the substitute process of authentication of said use side apparatus in accordance with the received request for acquiring information; and
when the authentication has been done normally, the main information is provided from said information source apparatus to said use side apparatus upon an instruction from said authentication substitute processing apparatus.

14. The information providing system as claimed in claim 10, wherein
a provider apparatus receives a request for acquiring the meta data from said use side apparatus;
said provider apparatus creates the meta data having the link element of which destination is set to the authentication substitute processing apparatus provided separately from the information source apparatus that manages information as an object of the meta data;
said provider apparatus returns the created meta data to said use side apparatus;
said provider apparatus receives a request for acquiring information based on the link element contained in the meta data from said use side apparatus;
said provider apparatus serving as said authentication substitute processing apparatus performs the substitute process of authentication of said use side apparatus in accordance with the received request for acquiring information; and
when the authentication has been done normally, said provider apparatus acquires the main information from said information source apparatus and provides the acquired main information to said use side apparatus.

15. The information providing system as claimed in one of claims 11, 12 and 14, wherein said provider apparatus creates the meta data of which contents are sorted in an order of time based on information from a plurality of said information source apparatuses.

16. The information providing system as claimed in one of claims 11, 13 and 14, wherein said provider apparatus creates the meta data each time the request for acquiring information is received from said information source apparatus, or based on information that has been collected previously.

17. The information providing system as claimed in claim 11, wherein said provider apparatus provides the main information, in response to the request for acquiring information from said use side apparatus, through said provider apparatus itself, or by causing said information source apparatus to perform redirection.

18. The information providing system as claimed in claim 12, wherein said authentication substitute processing apparatus provides the main information, in response to the request for acquiring information from said use side apparatus, through said authentication substitute processing apparatus itself, or by causing said information source apparatus to perform redirection.
